(19) United States
(12) Patent Application Publication
(10) Pub. No.: US 2004/0002974 A1
(43) Pub. Date: Jan. 1, 2004

(54) Thread based lock manager

(75) Inventors: Jody Kravitz, San Diego, CA (US); Shyh-Jye Chen, San Diego, CA (US); Tejaswini, San Diego, CA (US)

Correspondence Address: Pillsbury Winthrop LLP, Intellectual Property Group, 725 South Figueroa Street, Los Angeles, CA, 90017-5443, US

(73) Assignee: Intel Corporation, Santa Clara, CA

(21) Appl. No.: 10/180,135

(22) Filed: Jun. 27, 2002

(51) Int. Cl. G06F 17/30

(52) U.S. Cl. 707/8

(57) ABSTRACT

An arrangement is provided for thread based lock management. A lock manager is first initialized. A thread sends a request with respect to a lock associated with a shared resource to the thread based lock manager. Upon receiving the request, the lock manager determines the request type and associated lock operation requested. The request is then accordingly processed based on the request type. A reply is generated based on the outcome of the processing and returned to the thread.

### BACKGROUND

In a computing environment, resources may be shared. Resources may include, but not limited to, hardware, software, and information. For example, hardware components such as memory, hard disk, bus, or peripheral devices may be shared. Shared resources may also include data such as objects implemented in either platform dependent or independent forms.

Although resources may be shared, each use is usually exclusive. That is, only one user can access a resource at any given time. The exclusiveness may be necessary. For example, a hardware component can interact with only one user at a time. When data is shared, the integrity of shared information may be crucial. Different mechanisms such as semaphore or mutex have been employed to ensure the exclusiveness in resource sharing. When a shared resource is used, the status of a corresponding locking mechanism may be set so that it excludes others from accessing the same resource.

Resources may be shared at different levels. For instance, different applications may share resources. Different processes within an application may also share resources. Furthermore, processes that are either intra application or inter application may also share resources. Intra application processes refer to those that are within a same application; while inter application processes refer to those that belong to different applications. Resource sharing among intra application processes and inter application processes may also occur at the same time.

Modem programming paradigms support multi-thread applications that run on a single operating system. Threads may be at user level or kernel level. Threads may also be either intra process threads (threads in a same process) or inter process threads (threads from different processes). Such threads may share resources. Some operating systems support only user-level threads. Such operating systems may deploy a timer-based scheme to block multiple access to a same resource. For example, if process A is using resource X, all other processes that attempt to access resource X may be put to sleep for a fixed amount time specified by a timer. When process A completes its use, it releases X, which enables other processes to access X. This prevents intra process threads from sharing resources. For example, assume that process A has two threads, thread A1 and thread A2. In an operating system that supports only user-level threads, when A1 and A2 attempt to share resource X, a deadlock may occur. When A2 attempts to access resource X while A1 is using it, process A will be put to sleep. Without a time out mechanism, this will lead to a deadlock situation. Even with a time out mechanism, threads A1 and A2 can not effectively share resources. In addition, performance is degraded.

### BRIEF DESCRIPTION OF THE DRAWINGS

The inventions claimed and/or described herein are further described in terms of exemplary embodiments. These exemplary embodiments are described in detail with reference to the drawings. These embodiments are non-limiting exemplary embodiments, in which like reference numerals represent similar parts throughout the several views of the drawings, and wherein:

FIG. 1 depicts an exemplary framework that facilitates threads to share resources via a lock management mechanism, according to embodiments of the present invention;

FIG. 2 illustrates exemplary types of shared resources;

FIG. 3 is a high level functional block diagram of a lock management mechanism, according to embodiments of the present invention;

FIG. 4 illustrates exemplary types of lock management operations, according an embodiment of the present invention;

FIG. 5 is a flowchart of an exemplary process, in which a plurality of threads share resources via a lock management mechanism, according an embodiment of the present invention;

FIG. 6 is a flowchart of an exemplary initialization process, in which a lock manager is initialized to support lock management, facilitating resource sharing among threads, according to an embodiment of the present invention;

FIG. 7 is a flowchart of an exemplary process, in which a lock management request is analyzed and an appropriate action is performed to process the request, according to an embodiment of the present invention;

FIG. 8 is a flowchart of an exemplary lock creation process, in which a lock is created based on a request from a thread, according to an embodiment of the present invention;

FIG. 9 is a flowchart of an exemplary lock deletion process, in which a lock is deleted based on a request from a thread, according to an embodiment of the present invention;

FIG. 10 is a flowchart of an exemplary lock relinquishing process, in which a lock is relinquished based on a request from a thread, according to an embodiment of the present invention;

FIG. 11 is a flowchart of an exemplary lock taking process, in which a lock is taken for possession of a thread based on a request from the thread, according to an embodiment of the present invention; and

FIG. 12 is a flowchart of an exemplary lock cleaning process, in which any lock created by a requesting thread is deleted, according to an embodiment of the present invention.

### DETAILED DESCRIPTION

The processing described below may be performed by a properly programmed general-purpose computer alone or in connection with a special purpose computer. Such processing may be performed by a single platform or by a distributed processing platform. In addition, such processing and functionality can be implemented in the form of special purpose hardware or in the form of software or firmware being run by a general-purpose or network processor. Data handled in such processing or created as a result of such processing can be stored in any memory as is conventional in the art. By way of example, such data may be stored in a temporary memory, such as in the RAM of a given computer system or subsystem. In addition, or in the alternative, such data may be stored in longer-term storage devices, for example, magnetic disks, rewritable optical disks, and so on. For purposes of the disclosure herein, a computer-readable media may comprise any form of data storage mechanism, including such existing memory technologies as well as hardware or circuit representations of such structures and of such data.

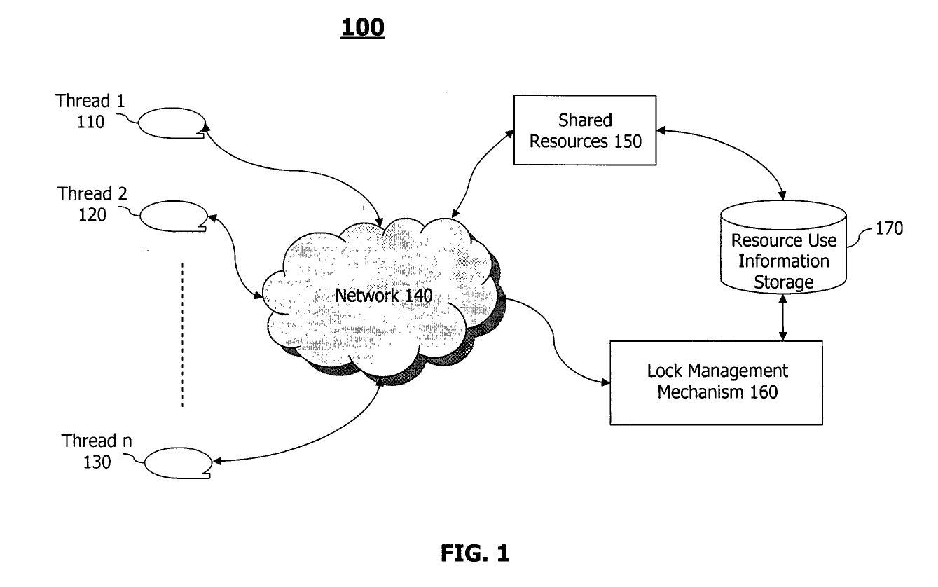

FIG. 1 depicts an exemplary framework 100 that facilitates a plurality of threads (thread 1 110, thread 2 120, . . . , thread n 130) to share resources 150 via a lock management mechanism 160, according to embodiments of the present invention. The threads 110, 120, . . . , 130 may correspond to one or more processes. Some threads may belong to the same process (intra threads) and some may be from different processes (inter threads). Threads communicate with the lock management mechanism 160 for any resource sharing tasks. The communication may be through a generic network 140 which may represent a bus, a local area network (LAN), a wide area network (WAN), the Internet, a proprietary network, or a wireless network.

The shared resources 150 may be physically located across the network 140. For example, threads may share a peripheral device (shared resource) such as a hard disk drive connected to a central processing unit (CPU), via a bus, on which the threads are residing and running. Shared resources 150 may also be distributed across the Internet. For instance, platform independent objects may be shared across different systems (e.g., clients or servers). Both the threads and the lock management mechanism 160 interact with the shared resources via the network 140.

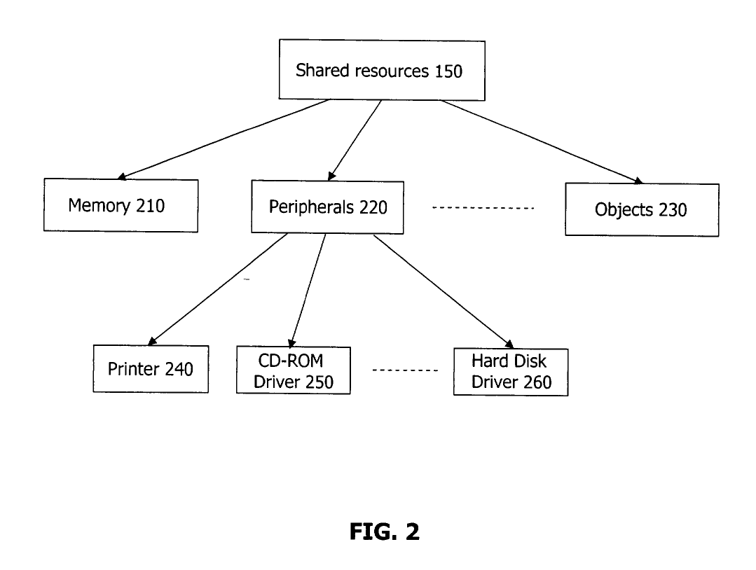

FIG. 2 illustrates exemplary types of shared resources. The shared resources 150 includes, but not limited to, memory 210, peripherals 220, . . . , and objects 230. The peripherals 220 may comprise a printer 240, a CD-ROM driver 250, . . . , and a hard disk drive 260. The shared objects 230 may include (not shown) common objects or proprietary objects. The former may be platform independent and the latter may be platform dependent.

To facilitate shared resource management, the lock management mechanism 160 may establish information related to the use and management of the shared resources 150 and may store such information in a resource use information storage 170. The resource use information may include both the resource information and the dynamic usage information. For example, resource information may indicate what kinds of resources exist. The resource information may be updated whenever a new resource becomes available or an existing resource is removed.

Dynamic usage information may include information about the locks corresponding to the available shared resources that are created to ensure their exclusive use Dynamic information may also include information related to the current exclusive usage of each shared resource such as which shared resource is currently used by which thread. In addition, the lock management mechanism 160 may maintain information about which thread is waiting for which shared resource. With such information, when a prior use of a shared resource is completed (the lock corresponding to the resource is accordingly released), the thread that is the first waiting in line for the shared resource will be permitted to acquire the released lock. During the management process, the lock management mechanism 160 continuously updates the information stored in the resource use information storage 170.

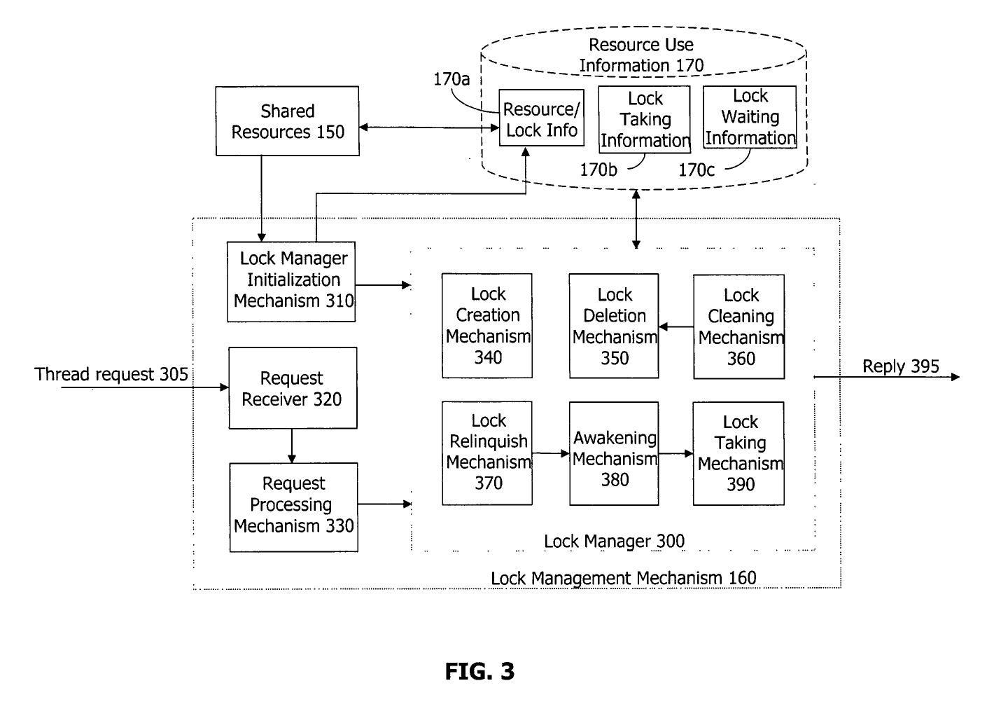

FIG. 3 is a high level functional block diagram of the lock management mechanism 160, in relation to the shared resources 150 and the resource use information storage 170, according to embodiments of the present invention. The lock management mechanism 160 comprises a lock manager 300, a lock manager initialization mechanism 310, a request receiver 320, and a request processing mechanism 330. The lock manager initialization mechanism 310 is responsible for initializing the lock manager 300 when the lock management mechanism 160 is deployed or whenever the lock management mechanism 160 is re-started.

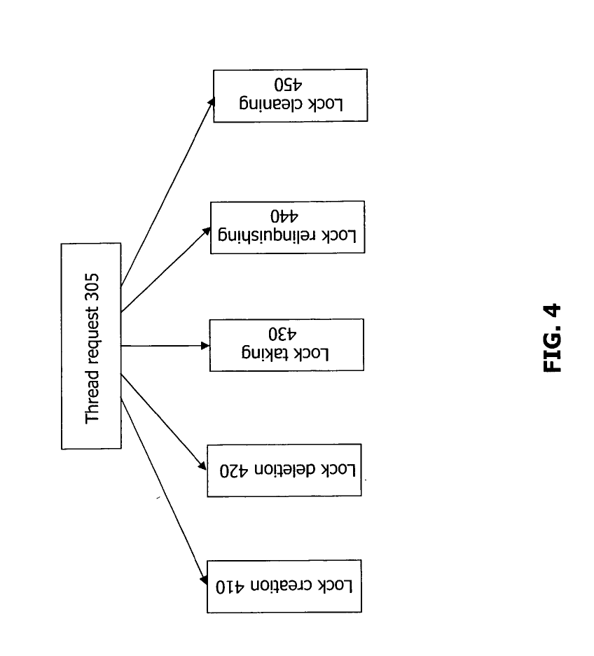

The request receiver 320 intercepts a thread request 305 sent from a thread. Such received thread request 305 may ask the lock management mechanism 160 to perform certain function related to a lock corresponding to a particular shared resource. The thread request 305 may be forwarded to the request processing mechanism 330 and processed to identify the type of the request so that appropriate lock management operations may be accordingly invoked. FIG. 4 illustrates exemplary types of lock management request. The thread request 305 may correspond to, but not limited to, one of a lock creation request 410, a lock deletion request 420, a lock taking request 430, a lock relinquishing request 440, and a lock cleaning request 450.

The lock creation request 410 may ask the lock management mechanism 160 to create a lock for a particular shared resource. The purpose of creating a lock for a shared resource may be to ensure its exclusive use. That is, the created lock may be used to guard against possible simultaneous access to the underlying shared resource. For example, if use a shared resource requires the acquisition of its corresponding lock first and the lock is managed in such a way that only one thread can acquire the lock at any time instance, the existence of a lock created with respect to a shared resource may ensure the intended exclusive use of the resource.

A thread that creates a lock is the owner of the lock. A lock owner may request to delete a previously created lock via the lock deletion request 420. The request may be validated according to whether the requesting thread is the creator of the lock. The deletion may be performed when the requesting thread is the creator of the lock. In addition, if the lock is currently in use, the operation of the lock deletion may be postponed until the lock is released from a prior use.

A thread may also request to take a lock that corresponds to a shared resource. The thread may send the lock taking request 430 to acquire the lock prior to its intended exclusive use of the shared resource. Once the lock is acquired, it prevents other thread from access the same shared resource. When the thread finishes its use of the shared resource, it may send a lock relinquishing request 440 to release the lock. When the lock management mechanism 160 processes a lock relinquishing request, it may examine whether there is any thread that is waiting for the lock. If there is, the lock management mechanism 160 wakes up the waiting thread and allow it to acquire the released lock.

A thread may create and own a plurality of locks. It may also delete more than one of its locks. For example, if a thread is exiting, it may delete all of the locks created by it. The lock cleaning request 450 is used for asking the lock management mechanism 160 to delete all the locks that belong to the thread. The lock cleaning request 450 may be provided with some owner information, based on which all locks owned by the specified owner are to be deleted.

Deleting a lock may be different from releasing a lock. Releasing a lock may mean that the control of the lock is released by a thread that previously has the control over it. After the release, the lock remains and is again available for other threads to take control. A deleted lock no longer exists. That is, a deleted lock is no longer available.

Through different lock management requests, a thread may exercise its control over different shared resources. Via the lock management mechanism 160, different threads may dynamically coordinate and share needed resources. A thread (e.g., thread 1 110) that uses certain shared resource may acquire the underlying lock corresponding to the resource. A different thread (e.g., thread 2 120) that needs the same resource may be, for example, put to sleep or put in waiting when the underlying lock is already in use. When the thread 1 110 requests to release the lock for which the thread 2 120 is waiting, the thread 2 may then be informed or awakened after the lock is released (by the lock management mechanism 160).

Referring again to FIG. 3, the lock management mechanism 160 may maintain a dynamic state of the resource use information and manage the locks, hence, the resources, accordingly. The resource use information may comprise descriptions of different aspects of lock management. For example, the resource use information storage 170 may include resource and lock information 170a, which describes the correspondence between shared resources and their locks. It may also include lock taking information 170b, which may describe which threads are in control of which locks at the moment. In addition, it may also include lock waiting information 170c, which may describe which threads are waiting for which locks. As discussed earlier, such information reflects a dynamic depiction of the current usage of the shared resources 150.

To support the above described lock operations, the lock manager 300 comprises a lock creation mechanism 340, a lock deletion mechanism 350, a lock cleaning mechanism 360, a lock relinquishing mechanism 370, a awakening mechanism 380, and a lock taking mechanism 390. Each of the sub mechanisms within the lock manager 300 performs a lock operation to satisfy a thread request from a thread. For example, if the thread 1 110 sends a lock creation request to the lock management mechanism 160, the request processing mechanism 330 recognizes that it is a request for creating a lock and invokes the lock creation mechanism 340 to perform the request lock creation operation. When a lock is created according to the request, the lock creation mechanism 340 returns a reply 395 to the requesting thread 110.

The reply 395 may be generated according to the status of the lock creation operation. If the creation operation is successful, the lock creation mechanism may return a success message, together with a lock ID representing the newly created lock, to the thread 110. In addition, the lock creation mechanism 340 may update the resource and lock information 170a in the resource use information storage 170 to record or register the newly created lock. If the operation fails, the lock creation mechanism 340 may return an error message to the thread 110 to indicate that the request can not be processed properly.

Other mechanisms in the lock manager 300 may perform different operations corresponding to different thread request types. For example, if the thread request is to delete a lock, the lock deletion mechanism 350 is invoked. Similarly, a lock cleaning request invokes the lock cleaning mechanism 360. A lock relinquishing request invokes the lock relinquishing mechanism 370. A lock taking request invokes the lock taking mechanism 390.

To delete a lock, the lock deletion mechanism 350 may examine whether the requesting thread is the creator of the lock. A deletion operation may be performed only when the requesting thread is the creator of the lock to be deleted. In addition, a lock that is currently in use may need to be deleted after the current use is completed. Upon the deletion of the lock, the lock deletion mechanism 350 may update the resource and lock information 170a in the resource use information storage 170. The lock deletion mechanism 350 makes sure that the operation is performed in a valid manner. Otherwise, it returns an error message to the requesting thread.

The lock cleaning operation is to delete all the locks created by the requesting thread. Therefore, the operation corresponding to a lock cleaning may be performed through a sequence of lock deletion operations. The lock cleaning mechanism 360 invokes the lock deletion mechanism 350 to perform individual lock deletion operations for each and every lock created by the requesting thread. After the deletion of each lock, the lock cleaning mechanism 360 may update the resource and lock information 170a in the resource use information storage 170.

When a thread requests to relinquish a lock, the lock relinquishing mechanism 370 is invoked. When a lock is released, if there is no other threads waiting for the lock, the lock relinquishing mechanism 370 may update the lock taking information 170b in the resource use information storage 170 by removing the lock from the lock taking list. If there is any thread waiting for the lock, the lock relinquishing mechanism 370 may then invoke the awakening mechanism 380 to wake up the waiting thread. Then the lock taking mechanism 390 may be subsequently invoked to permit the awakened thread to take the lock. This sequence of operation may lead to an update to both the lock waiting information 170c and the lock taking information 170b in the resource use information storage 170.

When a thread requests to take a lock, the lock taking mechanism is invoked to acquire the lock for the thread. If the lock is available, the lock taking mechanism 390 marks the lock as taken and may then update the lock taking information 170b in the resource use information storage 170. If the requested lock is current in use, the lock taking mechanism 390 may put the requesting thread to sleep and add it to the lock waiting list in 170c. If the requested lock does not exist, the lock taking mechanism 390 may generate an error message and returns it to the thread.

The mechanisms within the lock manager 300 may issue different types of error messages. One type may involve the error in the request itself. For example, a thread may request to perform some operation on a lock that does not exist. In this case, the request itself is not valid. A different type of error message is related to some error in performing the requested operation. For example, a thread may request to delete a lock for which the requesting thread is not the creator. In both situations, an underlying mechanism may generate the reply 395 according to the error detected. When a requested operation is successful, the underlying mechanism may generate a message indicating that the requested operation is successfully performed.

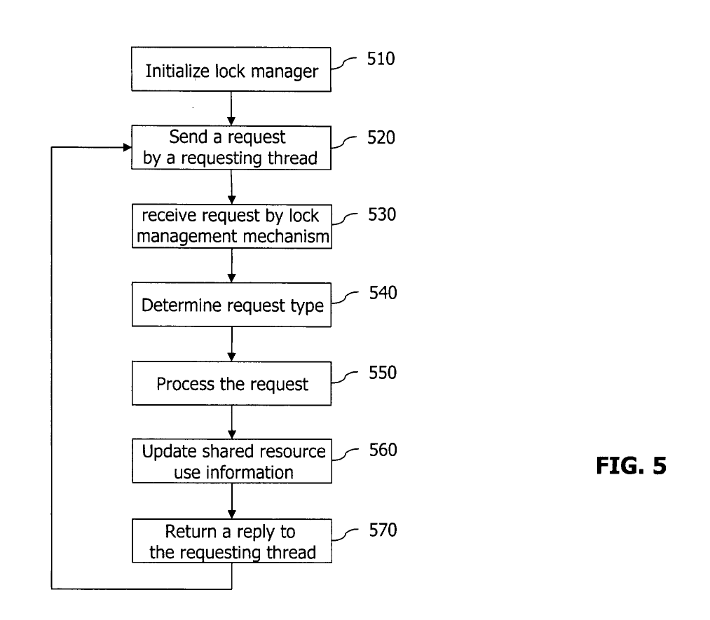

FIG. 5 is a flowchart of an exemplary process, in which a plurality of threads shares resources via the lock management mechanism 160, according an embodiment of the present invention. The lock manager 300 is first initiated at 510. The initialization may be performed when either the lock management mechanism 160 is deployed or when it is restarted. When the lock management mechanism 160 is in operation, a requesting thread sends, at 520, a request to the lock management mechanism 160. The request receiver 320 in the lock management mechanism 160 intercepts, at 530, the request and forwards it to the request processing mechanism 330. Upon receiving the request, the request processing mechanism determines, at 540, the request type and invokes necessary mechanisms in the lock manager 300 to perform the requested lock operation. The invoked mechanism processes, at 550, the request and performs the lock operation. Based on the lock operation result, the lock manager 300 updates, at 560, the relevant information in the resource use information storage 170 and returns, at 570, the reply 395 to the requesting thread.

When there are multiple threads sending requests to the lock management mechanism 160, the order in which the requests are processed may be according to the order the requests are received. The order to process received requests may also be prioritized using other pre-determined criteria. For example, some threads may be assigned higher priorities than others so that their requests may be processed immediately after arrival and some processing for requests for threads with lower priorities may need to be suspended temporarily.

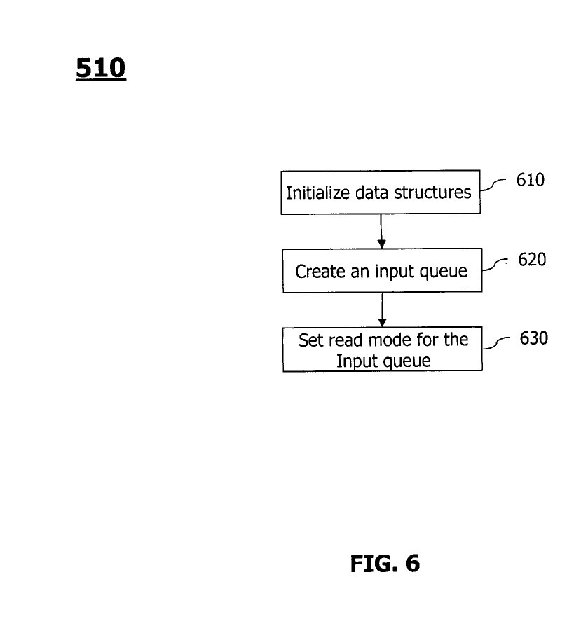

FIG. 6 is a flowchart of an exemplary initialization process, in which the lock manager initialization mechanism 310 set up necessary parameters relevant to the lock management mechanism 160. Various data structures are first initialized at 610. An input queue is created at 620 that may be used to host incoming requests and that may support access of such requests in a pre-determined order. The lock manager initialization mechanism 310 then sets, at 630, the mode of the input queue to be a read mode. Other initialization operations may also be performed (not shown). For example, when the lock manager management mechanism 160 is deployed, the resource use information may need to be set. Lock waiting and taking information may be set null and the resource and lock information may be set consisting of the available resources.

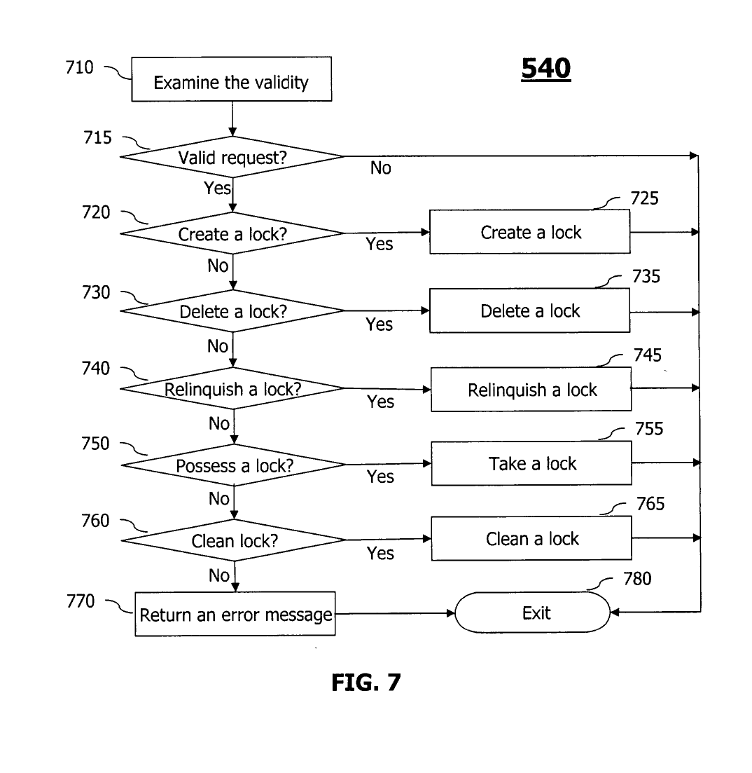

FIG. 7 is a flowchart of an exemplary process, in which the request processing mechanism 330 analyzes a lock management request and invokes appropriate mechanism to perform a requested lock operation, according to an embodiment of the present invention. The validity of a lock request is first examined at 710. If the lock request is not valid, the processing exits at 780. If the request is valid, determined at 715, the request processing mechanism 330 further determines the type of the requested lock operation and invoke appropriate mechanism to perform the operation.

If the lock request is to create a lock, determined at 720, the request processing mechanism invokes, at 725, the lock creation mechanism 340. If the lock request is to delete a lock, determined at 730, the request processing mechanism invokes, at 735, the lock deletion mechanism 350. If the lock request is to relinquish a lock, determined at 740, the request processing mechanism invokes, at 745, the lock relinquishing mechanism 370. If the lock request is to take a lock, determined at 750, the request processing mechanism invokes, at 755, the lock taking mechanism 390. If the lock request is to clean all the locks created by the requesting thread, determined at 760, the request processing mechanism invokes, at 765, the lock cleaning mechanism 360. There may be other types of lock operations (not shown in FIG. 7). In any specific system, the types of lock operations supported may depend on the needs of applications. When a request corresponds to none of a set of permitted lock operations (pre-determined according to application needs), the request processing mechanism 330 returns, at 770, an error message to the requesting thread prior to exit at 780.

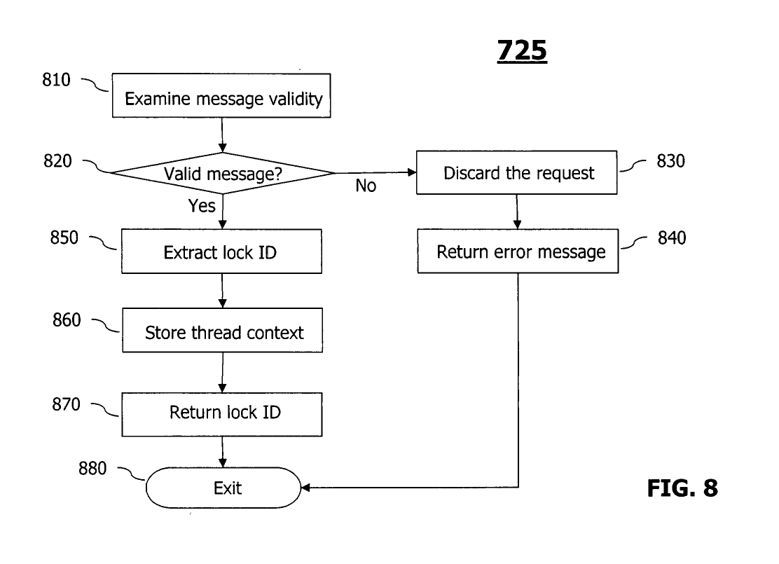

Different invocations described in FIG. 7 are further described in detail below. FIG. 8 is a flowchart of an exemplary lock creation process, in which a lock is created based on a request from a thread. The message contained in the thread request 305 is first examined at 810. This is to ensure that the request to create a lock is a valid request. This is determined at 820. A lock creation request may be invalid when a thread requests to create a lock for a non-existent shared resource. Therefore, even though the request seems to be valid to the request processing mechanism 330 (which may merely determines the type of a lock management request), it may fail the validity test when a particular lock operation mechanism examines its validity in light of the operation to be performed.

If a creation request is invalid, the lock creation mechanism 340 discards the request at 830 and subsequently returns, at 840, an error message to the requesting thread. If the request is valid, the lock creation mechanism 340 proceeds to create a lock. It first extracts, at 850, the identification of the lock. Such identification may uniquely identify a lock. The lock creation mechanism 340 then registers the contextual information about the requesting thread with lock related information. This is achieved by storing the context information of the thread at 860. The lock ID is then returned, at 870, to the requesting thread prior to exits the operation at 880.

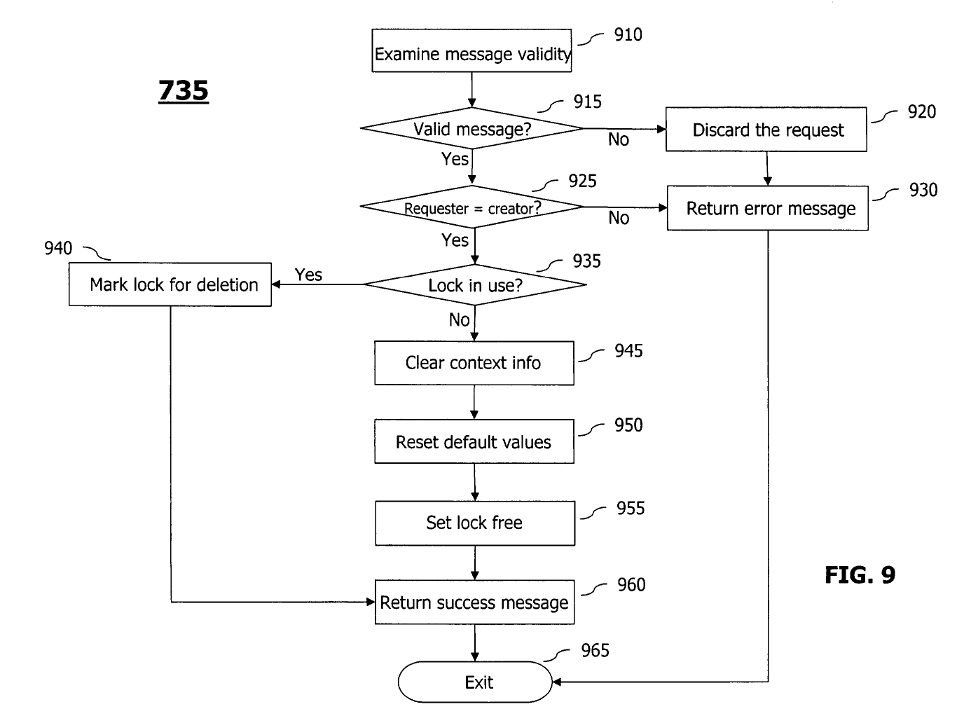

FIG. 9 is a flowchart of an exemplary lock deletion process, in which a lock is deleted based on a request from a thread, according to an embodiment of the present invention. The lock deletion request is first examined at 910 for its validity. If it is not valid, determined at 915, the lock deletion mechanism 350 discards the request at 920. An error message is generated and returned, at 930, to the thread prior to exit at 965.

If the deletion request is valid, the lock deletion mechanism 350 further examines, at 925, whether the requesting thread of the creator of the lock to be deleted. If the requesting thread is not the creator of the lock, the lock deletion mechanism 350 generates and returns an error message at 930 before it exits.

If the requesting thread is the creator of the lock to be deleted, the lock deletion mechanism 350 proceeds with the deletion operation. It first examines, at 935, whether the lock is currently in use. If the lock is currently in use, the lock deletion mechanism 350 marks the lock as for deletion at 940 and returns a success message to the thread at 960. If the lock is not in use, the lock deletion mechanism 350 clears, at 945, all the context information related to the requesting thread (creator), resets the default values at 950, and then sets, at 955, the lock as free. A success message is then returned, at 960, to the thread before exits the operation.

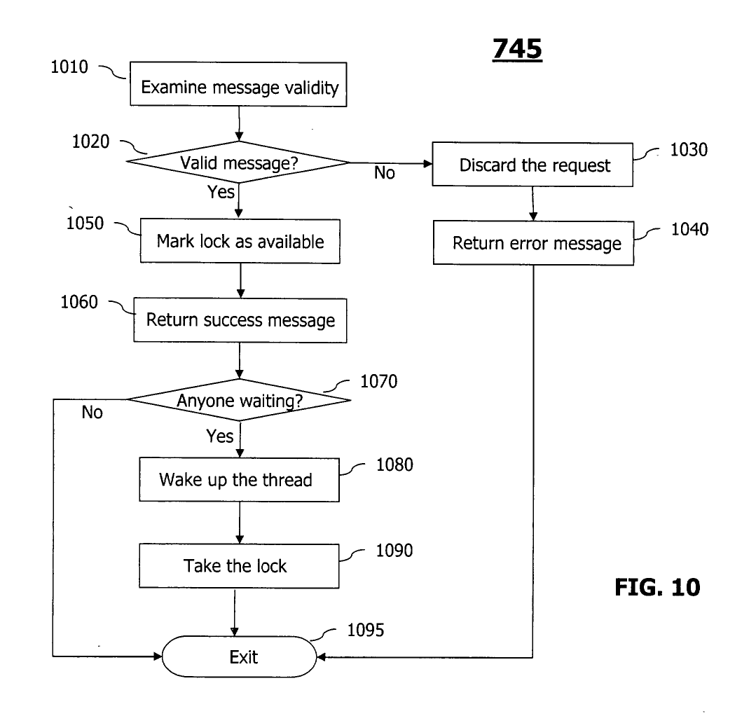

FIG. 10 is a flowchart of an exemplary lock relinquishing process, in which a lock is relinquished based on a request from a thread, according to an embodiment of the present invention. The lock relinquish request is first examined at 1010 for its validity. If the request to relinquish a lock is not valid, determined at 1020, the lock relinquishing mechanism 370 discards the request at 1030 and returns, at 1040, an error message to the requesting thread prior to exit at 1095.

If the relinquishing request is valid, the lock relinquishing mechanism 370 marks the lock as available at 1050 and returns a success message to the request thread at 1060. If there is any thread that is waiting for the lock (that is just released), determined at 1070, the lock relinquishing mechanism 370 invokes the awakening mechanism 380 at 1080 to wake up the thread that is waiting. Once the thread is awakened, the lock relinquishing mechanism 370 invokes the lock taking mechanism 390 at 1090 to take the lock that is just relinquished.

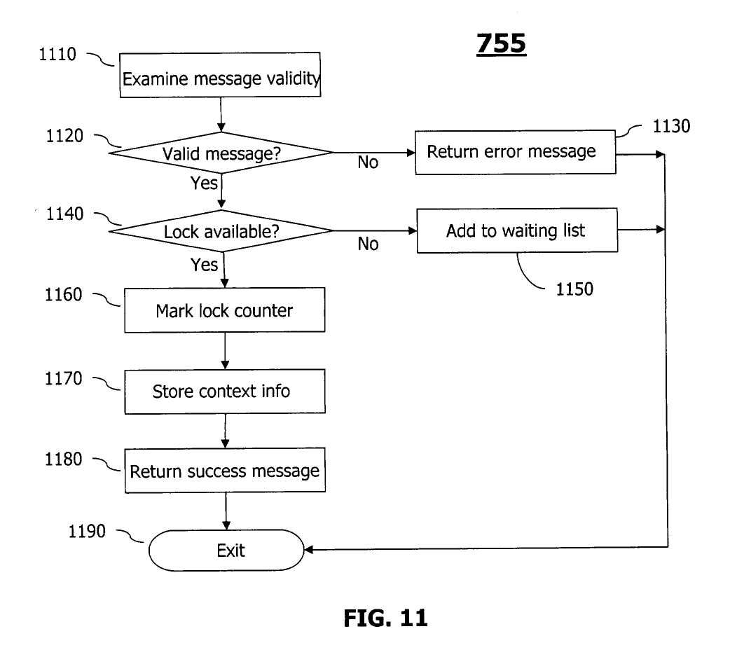

FIG. 11 is a flowchart of an exemplary lock taking process, in which a lock is taken in possession of a requesting thread, according to an embodiment of the present invention. The lock taking request is first examined at 1110 for its validity. If the request to take a lock is not valid, determined at 1120, the lock taking mechanism 390 discards the request at 1130 and then exits at 1190.

If the lock taking request is valid, the lock taking mechanism 390 further examines, at 1140, whether the lock desired is available. If the requested lock is not available, the lock taking mechanism 390 adds, at 1150, the requesting thread to a waiting list associated with the desired lock before exits at 1190. If the desired lock is available, the lock taking mechanism 390 marks the lock counter as taken at 1160 and stores the context information of the requesting thread at 1170. The lock taking mechanism 390 then returns a success message to the requesting thread at 1180.

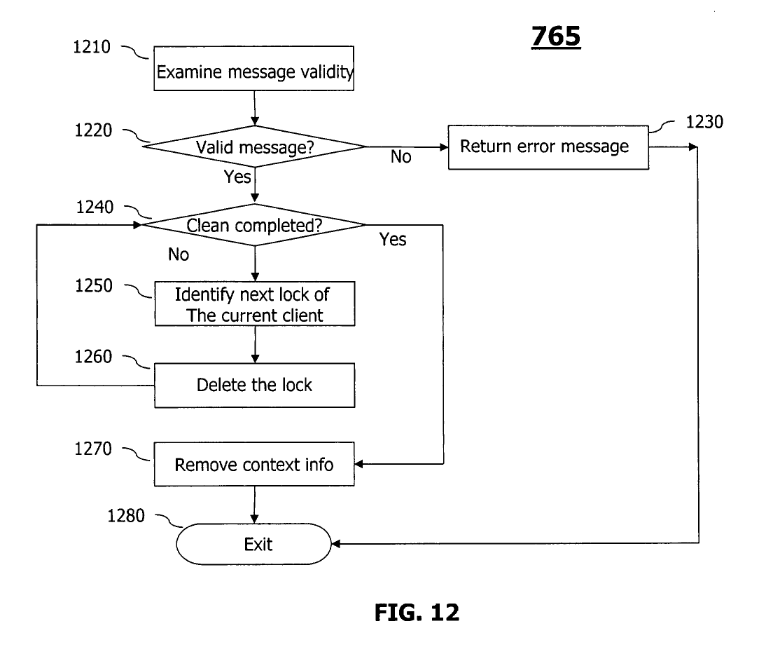

FIG. 12 is a flowchart of an exemplary lock cleaning process, in which any lock created by a requesting thread is deleted, according to an embodiment of the present invention. The lock cleaning request is first examined at 1210 for its validity. If the request to clean lock is not valid, determined at 1220, the lock cleaning mechanism 360 returns, at 1230, an error message to the requesting thread prior to exit at 1280.

If the lock cleaning request is valid, the lock cleaning mechanism 360 loops through the entire list of locks that have been created by the requesting thread. For each lock identified at 1250 as created by the requesting thread, the lock cleaning mechanism 360 invokes the lock deletion mechanism 350 at 1260 to delete the lock. The deletion process continues until all the locks created by the requesting thread are deleted. This is determined at 1240. It subsequently removes, at 1270, the context information related to the requesting thread from all the registries of the deleted locks at 1270 prior to exit at 1280.

While the invention has been described with reference to the certain illustrated embodiments, the words that have been used herein are words of description, rather than words of limitation. Changes may be made, within the purview of the appended claims, without departing from the scope and spirit of the invention in its aspects. Although the invention has been described herein with reference to particular structures, acts, and materials, the invention is not to be limited to the particulars disclosed, but rather can be embodied in a wide variety of forms, some of which may be quite different from those of the disclosed embodiments, and extends to all equivalent structures, acts, and, materials, such as are within the scope of the appended claims.

What is claimed is:

1. A method, comprising:
initializing a lock manager;
sending a request from a thread with respect to a lock associated with a shared resource;
determining the request type;
processing the request based on the request type; and
returning a reply to the thread based on the outcome of the processing.

2. The method according to claim 1, wherein the request type includes at least some of:
a lock creation request;
a lock deletion request;
a lock relinquishing request;
a lock taking request; and
a lock clean request.

3. The method according to claim 2, wherein the shared resource includes:
memory resource;
peripherals;
hardware resource; and
objects.

4. The method according to claim 3, wherein the reply includes at least one of:
a lock identification representing a lock;
a success message indicating that the request is successfully processed; or
an error message indicating that said processing is in error.

5. The method according to claim 4, wherein said processing comprises:
creating the lock associated with the shared resource if the request type is lock creation;
deleting the lock associated with the shared resource if the request type is lock deletion;
relinquishing the lock associated with the shared resource if the request type is lock relinquishing;
taking the lock associated with the shared resource if the request type is lock taking; and
cleaning at least one lock created by the thread if the request type is lock cleaning.

6. The method according to claim 5, wherein said creating the lock comprises:
examining the availability of the lock;
returning an error message if the lock is not available;
extracting a lock identification if the lock is available;
storing context information related to the thread in a storage associated with the lock; and
returning the lock identification.

7. The method according to claim 6, wherein said deleting the lock comprises:
examining whether the thread is the creator of the lock;
returning an error message if the thread is not the creator of the lock;
checking whether the lock is in use, if the thread is the creator of the lock;
marking the lock for deletion, if the lock is currently in use;
clearing the context information related to the creator of the lock stored in a storage associated with the lock, if the lock currently is not in use;
setting the lock free, if the lock currently is not in use; and
returning a success message to indicate that deletion of the lock is successful.

8. The method according to claim 7, wherein said relinquishing the lock comprises:
marking a lock counter associated with the lock to indicate that the lock is available;
returning a success message to indicate that the lock is successfully relinquished;
examining whether there is a pending lock taking request waiting for the availability of the lock; and
taking the lock, if there is at least one pending lock taking request.

9. The method according to claim 8, wherein said taking the lock comprises:
examining whether the lock is available;
adding the lock taking request to a waiting queue associated with the lock, if the lock is not available;
marking the lock counter associated with the lock to indicate that the lock is in use;
storing context information related to the thread in the storage associated with the lock; and
returning a success message to indicate that the lock is successfully taken.

10. The method according to claim 9, wherein said cleaning at least one lock created by the thread comprises:
identifying a lock created by the thread;
deleting the lock identified by said identifying;
repeating said identifying and said deleting until all the at least one lock created by the thread are deleted;
removing context information associated with the thread after said repeating.

11. The method according to claim 1, further comprising updating resource use information associated with the shared resource.

12. A system, comprising:
a plurality of threads;
at least one shared resource that can be shared among the plurality of threads; and
a lock management mechanism for managing at least one lock associated with the at least one shared resource to facilitate the at least one thread to share the resources.

13. The system according to claim 12, wherein the lock management mechanism comprises:
a request receiver for receiving a request from a thread with respect to a lock, the thread being one of the plurality of threads;
a request processing mechanism for processing the request to determine the request type based on the request received from the thread;
a lock manager for performing an operation with respect to the lock, the operation being determined based on the request type; and
a lock manager initialization mechanism for initializing the lock manager prior to the operation.

14. The system according to claim 13, wherein the lock manager comprises:
a lock creation mechanism for performing the operation of creating the lock;
a lock deletion mechanism for performing the operation of deleting the lock;
a lock cleaning mechanism for performing the operation of deleting any lock created by the thread;
a lock relinquishing mechanism for performing the operation of relinquishing the lock; and
a lock taking mechanism for performing the operation of taking the possession of the lock for the thread.

15. The system according to claim 14, further comprising an awakening mechanism for awaking another thread that is waiting for the availability of the lock that the thread requests to relinquish.

16. A lock management mechanism, comprising:
a request receiver for receiving a request from a thread with respect to a lock;
a request processing mechanism for processing the request to determine the request type based on the request received from the thread;
a lock manager for performing an operation with respect to the lock, the operation being determined based on the request type; and
a lock manager initialization mechanism for initializing the lock manager before the request is received.

17. The system according to claim 16, wherein the lock manager comprises:
a lock creation mechanism for performing the operation of creating the lock;
a lock deletion mechanism for performing the operation of deleting the lock;
a lock cleaning mechanism for performing the operation of deleting any lock created by the thread;
a lock relinquishing mechanism for performing the operation of relinquishing the lock; and
a lock taking mechanism for performing the operation of taking the possession of the lock for the thread.

18. The system according to claim 17, further comprising an awakening mechanism for awaking another thread that is waiting for the availability of the lock that the thread requests to relinquish.

19. An article comprising a storage medium having stored thereon instructions that, when executed by a machine, result in the following:
initializing a lock manager;
sending a request from a thread with respect to a lock associated with a shared resource;
determining the request type;
processing the request based on the request type; and
returning a reply to the thread based on the outcome of the processing.

20. The article comprising a storage medium having stored thereon instructions according to claim 19, wherein the request type includes:
a lock creation request;
a lock deletion request;
a lock relinquishing request;
a lock possession request; and
a lock clean request.

21. The article comprising a storage medium having stored thereon instructions according to claim 20, wherein the shared resource includes:
memory resource;
peripherals;
hardware resource; and
objects.

22. The article comprising a storage medium having stored thereon instructions according to claim 21, wherein the reply includes at least some of:
a lock identification representing a lock;
a success message indicating that the request is successfully processed; or
an error message indicating that said processing is in error.

23. The article comprising a storage medium having stored thereon instructions according to claim 22, wherein said processing comprises:
creating the lock associated with the shared resource if the request type is lock creation;
deleting the lock associated with the shared resource if the request type is lock deletion;
relinquishing the lock associated with the shared resource if the request type is lock relinquishing;
taking the lock associated with the shared resource if the request type is lock taking; and
cleaning at least one lock created by the thread if the request type is lock cleaning.

24. The article comprising a storage medium having stored thereon instructions according to claim 23, wherein said creating the lock comprises:
examining the availability of the lock;
returning an error message if the lock is not available;
extracting a lock identification if the lock is available;
storing context information related to the thread in a storage associated with the lock; and
returning the lock identification.

25. The article comprising a storage medium having stored thereon instructions according to claim 24, wherein said deleting the lock comprises:
examining whether the thread is the creator of the lock;
returning an error message if the thread is not the creator of the lock;
checking whether the lock is in use, if the thread is the creator of the lock;
marking the lock for deletion, if the lock is currently in use;
clearing the context information related to the creator of the lock stored in a storage associated with the lock, if the lock currently is not in use;
setting the lock free, if the lock currently is not in use; and
returning a success message to indicate that deletion of the lock is successful.

26. The article comprising a storage medium having stored thereon instructions according to claim 25, wherein said relinquishing the lock comprises:
marking a lock counter associated with the lock to indicate that the lock is available;
returning a success message to indicate that the lock is successfully relinquished;
examining whether there is a pending lock taking request waiting for the availability of the lock; and
taking the lock, if there is at least one pending lock taking request.

27. The article comprising a storage medium having stored thereon instructions according to claim 26, wherein said taking the lock comprises:
examining whether the lock is available;
adding the lock taking request to a waiting queue associated with the lock, if the lock is not available;
marking the lock counter associated with the lock to indicate that the lock is in use;
storing context information related to the thread in the storage associated with the lock; and
returning a success message to indicate that the lock is successfully taken.

28. The article comprising a storage medium having stored thereon instructions according to claim 27, wherein said cleaning at least one lock created by the thread comprises:
identifying a lock created by the thread;
deleting the lock identified by said identifying;
repeating said identifying and said deleting until all the at least one lock created by the thread are deleted;
removing context information associated with the thread after said repeating.

29. The article comprising a storage medium having stored thereon instructions according to claim 19, the instructions, when executed by a machine, further result in updating resource use information associated with the shared resource.
